(19) United States
(12) Patent Application Publication
(10) Pub. No.: US 2026/0269129 A1
(43) Pub. Date: Sep. 10, 2026

(54) MULTILAYER CERAMIC CAPACITOR

(71) Applicant: Murata Manufacturing Co., Ltd., Nagaokakyo-shi (JP)

(72) Inventors: Yuichiro MORIMOTO, Nagaokakyo-shi (JP); Hiroyuki YOSHIOKA, Nagaokakyo-shi (JP)

(21) Appl. No.: 19/535,147

(22) Filed: Feb. 10, 2026

(30) Foreign Application Priority Data
Mar. 7, 2025 (JP) 2025-036611

(51) Int. Cl. H01G 4/232; H01G 4/12; H01G 4/248; H01G 4/30

(52) U.S. Cl. CPC H01G 4/232; H01G 4/248; H01G 4/30; H01G 4/12

(57) ABSTRACT

A multilayer ceramic capacitor includes a multilayer body including first and second inner electrodes, and first and second outer electrodes. The first outer electrode includes first conductor portions on main surfaces and a second conductor portion on a first end surface and coupled to the first conductor portions. The first conductor portions include first residual stress portions in which residual stresses are present. The second conductor portion includes a second residual stress portion in which residual stresses are present. Residual stresses in the first residual stress portions are oriented in directions away from the first end surface with respect to a length direction. Residual stresses in the second residual stress portion are oriented in directions toward one-half of a height of the multilayer body with respect to a lamination direction.

### CROSS REFERENCE TO RELATED APPLICATIONS

This application claims the benefit of priority to Japanese Patent Application No. 2025-036611 filed on Mar. 7, 2025. The entire contents of this application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors are widely used as decoupling capacitors used for stabilizing a supply voltage provided to an integrated circuit (IC) that operates at high speed (for example, Japanese Unexamined Patent Application Publication No. 2019-179928).

### SUMMARY OF THE INVENTION

When an external stress of deflection or the like is applied after substrate mounting, a crack sometimes occurs from an end portion of an outer electrode of the multilayer ceramic capacitor. Further, manufacturing steps for the multilayer ceramic capacitor include a step of applying a high voltage to remove defective products having a low withstand voltage. In this step, when a voltage greater than or equal to a certain value is applied, an electrostrictive crack sometimes occurs. Accordingly, a multilayer ceramic capacitor that can achieve both improvement in mechanical strength and improvement in electrostrictive crack resistance is desired.

Example embodiments of the present invention provide multilayer ceramic capacitors that each achieve both improvement in mechanical strength and improvement in electrostrictive crack resistance.

The present inventors have newly discovered multilayer ceramic capacitors that each achieve both improvement in mechanical strength and improvement in electrostrictive crack resistance as a result of extensive studies.

A multilayer ceramic capacitor according to an example embodiment of the present invention includes a multilayer body including a plurality of dielectric layers laminated and a plurality of inner electrode layers laminated on the dielectric layers. The multilayer body includes main surfaces including a first main surface and a second main surface opposed to each other in a lamination direction, end surfaces including a first end surface and a second end surface opposed to each other in a length direction orthogonal to the lamination direction, and side surfaces including a first side surface and a second side surface opposed to each other in a width direction orthogonal to the lamination direction and the length direction. The multilayer ceramic capacitor also includes a first outer electrode on the first end surface and on a portion of the main surfaces and a second outer electrode on the second end surface and on a portion of the main surfaces. The plurality of inner electrode layers include first inner electrode layers on the plurality of dielectric layers and extending to the first end surface and second inner electrode layers on the plurality of dielectric layers and extending to the second end surface. The first outer electrode is connected to the first inner electrode layers. The second outer electrode is connected to the second inner electrode layers. The first outer electrode includes a first conductor portion on one of the main surfaces and a second conductor portion on the first end surface and coupled to the first conductor portion. The first conductor portion includes a first residual stress portion in which a residual stress is present. The second conductor portion includes a second residual stress portion in which a residual stress is present. The residual stress in the first residual stress portion is oriented in a direction away from the first end surface with respect to the length direction. The residual stress in the second residual stress portion is oriented in a direction toward one-half of the height of the multilayer body with respect to the lamination direction.

According to example embodiments of the present invention, it is possible to achieve both improvement in mechanical strength and improvement in electrostrictive crack resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to an example embodiment of the present invention.

FIG. 2 is a cross-sectional view (LT cross-sectional view) of the multilayer ceramic capacitor taken along line II-II at a central portion in a width direction depicted in FIG. 1.

FIG. 3 is a cross-sectional view (WT cross-sectional view) of the multilayer ceramic capacitor taken along line III-III in FIG. 1.

FIG. 4 is an enlarged cross-sectional view (LT cross-sectional view) of a multilayer ceramic capacitor of a comparative example.

FIG. 5 is an enlarged cross-sectional view (LT cross-sectional view) of the multilayer ceramic capacitor of the comparative example.

FIG. 6 is an enlarged cross-sectional view (LT cross-sectional view) of a multilayer ceramic capacitor according to an example embodiment of the present invention.

FIG. 7 is an enlarged cross-sectional view (LT cross-sectional view) of a multilayer ceramic capacitor according to an example embodiment of the present invention.

FIG. 8 is a table indicating experimental results according to an example embodiment of the present invention.

### DETAILED DESCRIPTION OF THE EXAMPLE EMBODIMENTS

Multilayer ceramic capacitors according to example embodiments of the present invention is described below. However, the present invention is not limited thereto. Further, in some cases, the drawings are schematically depicted in a simplified manner for describing the content of example embodiments of the present invention, and the ratio of dimensions in a depicted component or between depicted components does not coincide with the ratio of these dimensions described in the specification. In addition, there are a case in which a component described in the specification is omitted in the drawing, a case in which a component described in the specification is depicted with a reduced number of components for simplification, and the like.

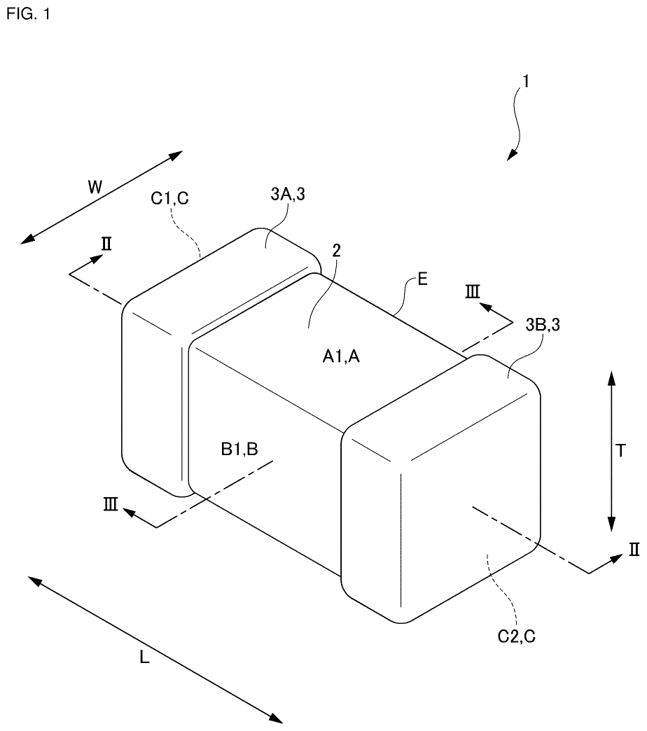

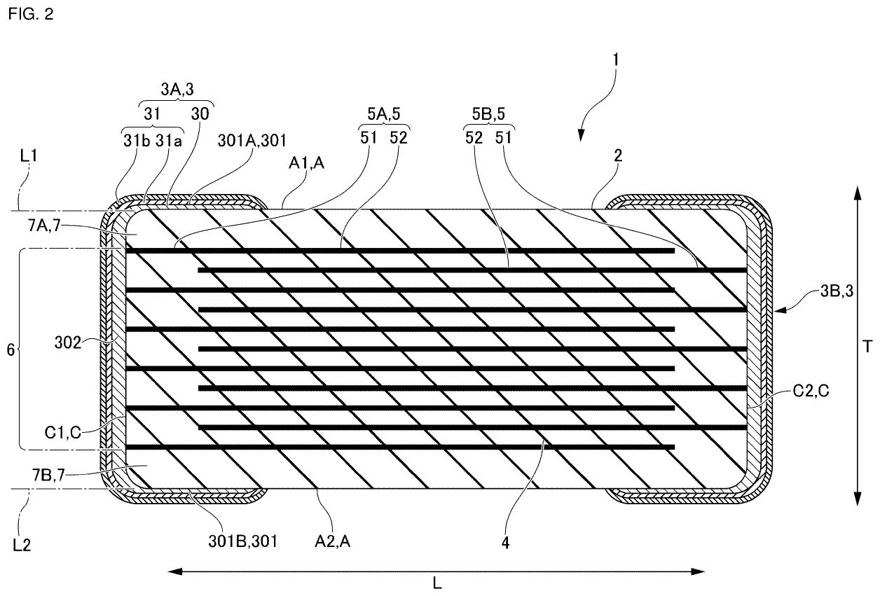

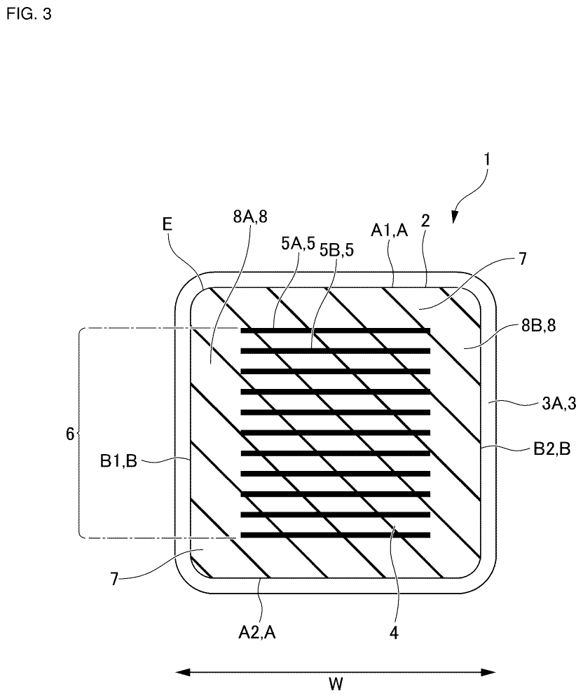

FIGS. 1 to 3 depict shape and structure of a multilayer ceramic capacitor 1. FIG. 1 is a schematic perspective view of the multilayer ceramic capacitor 1. FIG. 2 is a cross-sectional view (LT cross-sectional view) of the multilayer ceramic capacitor 1 taken along line II-II at a central portion in a width direction W depicted in FIG. 1. FIG. 3 is a cross-sectional view (WT cross-sectional view) of the multilayer ceramic capacitor 1 taken along line III-III in FIG. 1. In FIG. 2, a virtual line L1 is a line obtained by extending a first main surface A1. A virtual line L2 is a line obtained by extending a second main surface A2. In the following description of the structure of the multilayer ceramic capacitor 1, a direction in which dielectric layers 4 and inner electrode layers 5 are laminated is defined as a lamination direction T. Further, a length direction L orthogonal to the lamination direction T and the width direction W orthogonal to the lamination direction T and the length direction L are used. In the present example embodiment, the width direction W, the length direction L, and the lamination direction T are orthogonal to each other. However, these directions are not necessarily limited to such a relationship as to be orthogonal to each other, and may be in such a relationship as to intersect each other.

As depicted in FIGS. 1 to 3, the multilayer ceramic capacitor 1 has a substantially rectangular parallelepiped shape. The multilayer ceramic capacitor 1 includes a multilayer body 2 and a pair of outer electrodes 3. The multilayer body 2 includes a plurality of dielectric layers 4 laminated and a plurality of inner electrode layers 5 laminated on the dielectric layers 4. The plurality of inner electrode layers 5 are laminated on the dielectric layers 4.

The multilayer body 2 includes main surfaces A including the first main surface A1 and the second main surface A2, end surfaces C including a first end surface C1 and a second end surface C2, and side surfaces B including a first side surface B1 and a second side surface B2. The first main surface A1 and the second main surface A2 are opposed to each other in the lamination direction T. The first end surface C1 and the second end surface C2 are opposed to each other in the length direction L. The length direction L is orthogonal to the lamination direction T. The first side surface B1 and the second side surface B2 are opposed to each other in the width direction W. The width direction W is orthogonal to the lamination direction T and the length direction L.

When it is not required to particularly distinguish between the first main surface A1 and the second main surface A2, they are collectively referred to as the main surfaces A. When it is not required to particularly distinguish between the first side surface B1 and the second side surface B2, they are collectively referred to as the side surfaces B. When it is not required to particularly distinguish between the first end surface C1 and the second end surface C2, they are collectively referred to as the end surfaces C.

The multilayer body 2 has a rectangular or substantially rectangular parallelepiped shape. The multilayer body 2 includes a capacitance generating portion 6, outer layer portions 7 each disposed on the main surface A side of the capacitance generating portion 6, and side gap portions 8. It is preferable that ridge line portions E be rounded in the multilayer body 2. The ridge line portion E is a portion where two surfaces of the multilayer body 2, that is, the main surface A and the side surface B, the main surface A and the end surface C, or the side surface B and the end surface C, intersect each other, and also includes a corner portion where the main surface A, the side surface B, and the end surface C intersect each other. Irregularities or the like may be provided on a portion or an entirety of the main surfaces A, the side surfaces B, and the end surfaces C.

The capacitance generating portion 6 includes a plurality of sets of dielectric layers 4 and inner electrode layers 5 alternately laminated along the lamination direction T. Specifically, in the capacitance generating portion 6, first inner electrode layers 5A and second inner electrode layers 5B are alternately laminated with the dielectric layers 4 interposed therebetween.

It is preferable that the number of dielectric layers 4 be 500 or more and 2000 or less, for example. The dielectric layer 4 includes a ceramic material. As the ceramic material, for example, a dielectric ceramic including BaTiO₃, CaTiO₃, SrTiO₃, CaZrO₃, or the like as a main component is used, for example. In addition, as the ceramic material, a material obtained by adding at least one of subcomponents such as an Mn compound, an Fe compound, a Cr compound, a Co compound, or a Ni compound to these main components may be used, for example. It is preferable that the thickness of the dielectric layer be about 0.5 μm or more and about 6.3 μm or less, for example.

The first inner electrode layer 5A and the second inner electrode layer 5B can be formed of, for example, an appropriate conductive material such as a metal like Ni, Cu, Ag, Pd, or Au or an alloy including at least one of these metals like an Ag—Pd alloy, for example.

The plurality of inner electrode layers 5 include a plurality of first inner electrode layers 5A and a plurality of second inner electrode layers 5B. The first inner electrode layers 5A are disposed on the plurality of dielectric layers 4. The first inner electrode layers 5A are extended to the first end surface C1. The shape of the first inner electrode layer 5A is not particularly limited, but is preferably rectangular. Corner portions thereof may be rounded. The second inner electrode layers 5B are disposed on the plurality of dielectric layers 4. The second inner electrode layers 5B are extended to the second end surface C2. The shape of the second inner electrode layer 5B is not particularly limited, but is preferably rectangular. Corner portions thereof may be rounded. The first inner electrode layers 5A and the second inner electrode layers 5B are alternately disposed. When it is not required to particularly distinguish between the first inner electrode layer 5A and the second inner electrode layer 5B, they are collectively referred to as the inner electrode layers 5. An Sn layer may be included between the first inner electrode layer 5A and the dielectric layer 4, and between the second inner electrode layer 5B and the dielectric layer 4. The inclusion of the Sn layer can relieve electric field concentration at the interface between the inner electrode layer 5 and the dielectric layer 4, leading to improvement in reliability under a high-temperature load.

The inner electrode layer 5 includes an opposing portion 52 and an extended portion 51. The opposing portions 52 are opposed to each other between the first inner electrode layer 5A and the second inner electrode layer 5B. The extended portions 51 are not opposed to each other between the first inner electrode layer 5A and the second inner electrode layer 5B. The extended portions 51 are extended from the opposing portions 52 toward one end surface C side. An end portion of each extended portion 51 is exposed at the end surface C and is electrically connected to the outer electrode 3. The direction in which the extended portion 51 extends differs between the first inner electrode layer 5A and the second inner electrode layer 5B. The extended portions 51 are alternately extended toward the first end surface C1 side and the second end surface C2 side. Further, a charge is accumulated between the opposing portions 52 of the first inner electrode layer 5A and the second inner electrode layer 5B adjacent to each other in the lamination direction T, thus allowing functioning as a capacitor.

It is preferable that the total number of first inner electrode layers 5A and second inner electrode layers 5B be 500 or more and 2000 or less, for example. The number of first inner electrode layers 5A is not particularly limited, but is preferably, for example, 250 or more and 1000 or less. The number of second inner electrode layers 5B is not particularly limited, but is preferably, for example, 250 or more and 1000 or less. The thickness of the first inner electrode layer 5A is not particularly limited, but is preferably, for example, about 0.4 μm or more and about 1.3 μm or less. The thickness of the second inner electrode layer 5B is not particularly limited, but is preferably, for example, about 0.4 μm or more and about 1.3 μm or less.

The outer layer portions 7 are disposed on one main surface A side and the other main surface A side of the capacitance generating portion 6. The outer layer portion 7 preferably includes the same material as the dielectric layer 4 of the capacitance generating portion 6. The outer layer portions 7 include a first outer layer portion 7A and a second outer layer portion 7B. The first outer layer portion 7A is located on the first main surface A1 side of the multilayer body 2. The first outer layer portion 7A is located between the first main surface A1 and the capacitance generating portion 6. The first outer layer portion 7A is an aggregate of dielectric layers located between the first main surface A1 and the capacitance generating portion 6 closest to the first main surface A1. The second outer layer portion 7B is located on the second main surface A2 side of the multilayer body 2. The second outer layer portion 7B is located between the second main surface A2 and the capacitance generating portion 6. The second outer layer portion 7B is an aggregate of dielectric layers located between the second main surface A2 and the capacitance generating portion 6 closest to the second main surface A2. A region interposed between the first outer layer portion 7A and the second outer layer portion 7B is the capacitance generating portion 6.

The side gap portions 8 are disposed on one side surface B side and the other side surface B side of the capacitance generating portion 6 in the multilayer body 2. The side gap portion 8 preferably is integrally formed of the same material as the dielectric layer 4. The side gap portions 8 include a first side gap portion 8A and a second side gap portion 8B. The first side gap portion 8A is located between the capacitance generating portion 6 and the first side surface B1. The second side gap portion 8B is located between the capacitance generating portion 6 and the second side surface B2.

The pair of outer electrodes 3 are disposed at both ends of the multilayer body 2. Specifically, the outer electrodes 3 are disposed on both end surfaces C of the multilayer body 2. The pair of outer electrodes 3 include a first outer electrode 3A and a second outer electrode 3B. The first outer electrode 3A is disposed on the first end surface C1. The first outer electrode 3A is connected to the first inner electrode layers 5A. The second outer electrode 3B is disposed on the second end surface C2. The second outer electrode 3B is connected to the second inner electrode layers 5B. The outer electrode 3 covers not only the end surface C but also portions of the main surfaces A and the side surfaces B on the end surface C side. The outer electrode 3 includes an underlying electrode layer 30 and a plated layer 31 on a surface of the underlying electrode layer 30.

The underlying electrode layer 30 is electrically connected to the end portions of the extended portions 51 of the inner electrode layers 5 exposed at the end surface C. The underlying electrode layer 30 is, for example, a baked layer. When the underlying electrode layer 30 is a baked layer, it is preferable that the underlying electrode layer 30 include a conductive metal and either glass or ceramic or both. In the present example embodiment, the underlying electrode layer 30 includes a conductive metal and glass. Thus, the adhesion between the end surface C of the multilayer body 2 and the underlying electrode layer 30 is improved, and the intrusion of moisture into the multilayer body 2 can be reduced or prevented.

The conductive metal of the underlying electrode layer 30 includes, for example, at least one selected from Cu, Ni, Ag, Pd, an Ag—Pd alloy, Au, and the like.

The glass of the underlying electrode layer 30 includes at least one selected from B, Si, Ba, Mg, Al, Li, and the like. Further, when a ceramic component is included, the same type of ceramic component as that of the dielectric layer may be used as the ceramic component, or a different type of ceramic component may be used.

It is preferable that the dimension of the multilayer ceramic capacitor 1 in the length direction L be about 1.00 mm or more and about 3.50 mm or less, for example. The dimension of the multilayer ceramic capacitor 1 in the length direction L may be about 0.10 mm or more and about 3.50 mm or less, for example. It is preferable that the dimension of the multilayer ceramic capacitor 1 in the width direction W be about 0.50 mm or more and about 2.80 mm or less, for example. The dimension of the multilayer ceramic capacitor 1 in the width direction W may be about 0.05 mm or more and about 2.80 mm or less, for example. It is preferable that the dimension of the multilayer ceramic capacitor 1 in the lamination direction T be about 0.50 mm or more and about 2.80 mm or less, for example. The dimension of the multilayer ceramic capacitor 1 in the lamination direction T may be about 0.05 mm or more and about 2.80 mm or less, for example.

The first outer electrode 3A includes first conductor portions 301 and a second conductor portion 302. Specifically, the underlying electrode layer 30 includes the first conductor portions 301 and the second conductor portion 302. The first conductor portion 301 is disposed on the first main surface A1. The first conductor portion 301 is a portion appearing to be obtained by folding the first outer electrode 3A toward the central side of the main surface A. In the present specification, the first conductor portion 301 is sometimes referred to as a folded portion. The first conductor portions 301 include a first conductor portion 301A and a first conductor portion 301B. In an LT cross-sectional view, the first conductor portion 301A is connected to an end portion of the second conductor portion 302 on the first main surface A1 side. In an LT cross-sectional view, the first conductor portion 301B is connected to an end portion of the second conductor portion 302 on the second main surface A2 side. The first conductor portion 301 is located outside the multilayer body 2 in an LT cross-sectional view. Specifically, in an LT cross-sectional view, the first conductor portion 301A shows a portion on the outer side relative to the virtual line L1 with respect to the center of the multilayer body 2. In an LT cross-sectional view, the first conductor portion 301B shows a portion on the outer side relative to the virtual line L2 with respect to the center of the multilayer body 2.

The second conductor portion 302 is disposed on the first end surface C1 and is coupled to the first conductor portions 301. Specifically, one end of the second conductor portion 302 is coupled to the first conductor portion 301A. The other end of the second conductor portion 302 is coupled to the first conductor portion 301B.

The baked layer is a layer formed by applying conductive paste including glass and a metal to the multilayer body and baking it. The baked layer may include a plurality of layers. It is preferable that the thickness of a first end-surface baked layer located at a central portion of the first end surface C1 be, for example, about 30 μm or more and about 130 μm or less, for example. It is preferable that the thickness of a second end-surface baked layer located at a central portion of the second end surface C2 be, for example, about 30 μm or more and about 130 μm or less, for example.

It is preferable that the thickness in the height direction connecting the first main surface and the second main surface at central portions in the length direction connecting the first end surface and the second end surface in the first end-surface baked layer located on a portion of the first main surface A1 and on a portion of the second main surface A2 be, for example, about 20 μm or more and about 100 μm or less.

It is preferable that the thickness in the height direction connecting the first main surface and the second main surface at central portions in the length direction connecting the first end surface and the second end surface in the second end-surface baked layer located on a portion of the first main surface A1 and on a portion of the second main surface A2 be, for example, approximately 20 μm or more and 100 μm or less.

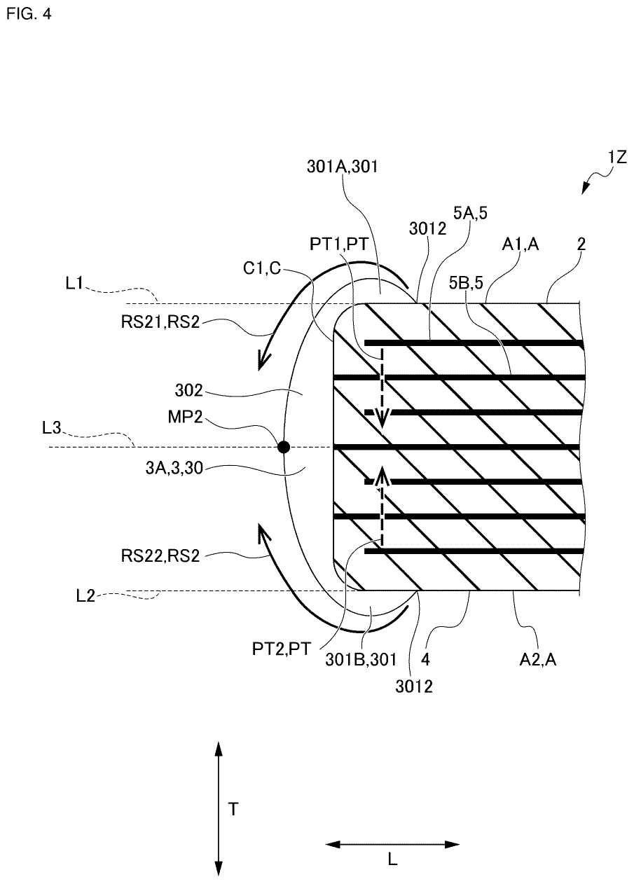

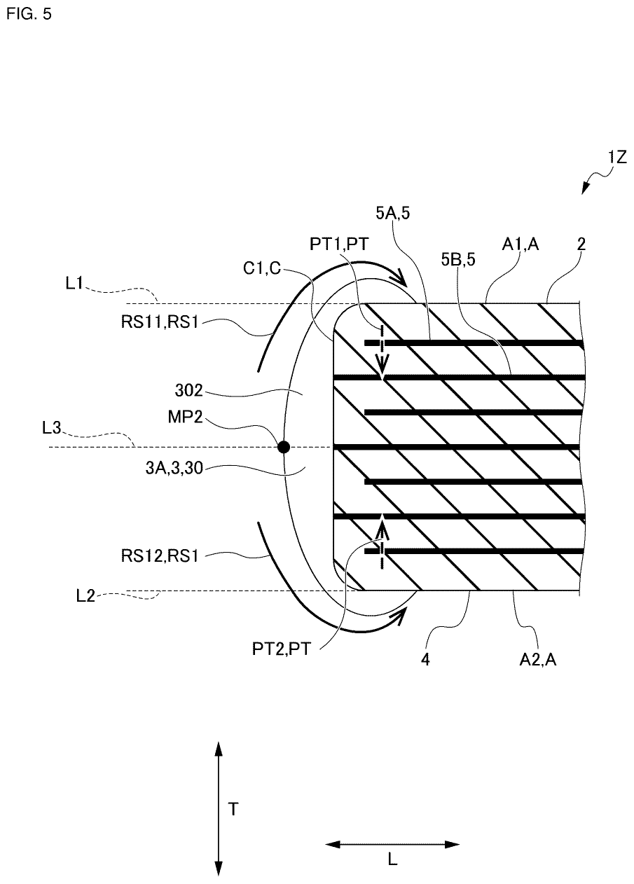

With reference to FIGS. 4 and 5, residual stresses of the first outer electrode 3A of a multilayer ceramic capacitor 1Z of a comparative example are described. FIG. 4 is an enlarged cross-sectional view (LT cross-sectional view) of the multilayer ceramic capacitor 1Z of the comparative example. FIG. 5 is an enlarged cross-sectional view (LT cross-sectional view) of the multilayer ceramic capacitor 1Z of the comparative example. In FIGS. 4 and 5, the plated layer 31 is omitted. That is, in FIGS. 4 and 5, only the underlying electrode layer 30 of the first outer electrode 3A is depicted. In FIGS. 4 and 5, a virtual line L3 is a line that passes through a position at one-half of the height of the multilayer body 2 with respect to the lamination direction T. That is, the virtual line L3 is a line that passes through the center of the first end surface C1 in the lamination direction T.

First, with reference to FIG. 4, the residual stresses of the first outer electrode 3A in a case in which sandblasting treatment is not performed are described. FIG. 4 is an enlarged cross-sectional view (LT cross-sectional view) of the multilayer ceramic capacitor 1Z of the comparative example in the case in which sandblasting treatment is not performed on the first outer electrode 3A. In FIG. 4, solid arrows indicate residual stresses RS2 of the first outer electrode 3A. The residual stresses RS2 include a residual stress RS21 and a residual stress RS22. In FIG. 4, dashed arrows indicate forces PT applied to the multilayer body 2 in the lamination direction T by the residual stresses RS2. The forces PT include a force PT1 and a force PT2. In FIG. 4, a maximum-thickness point MP2 indicates a point at which the thickness of the second conductor portion 302 is maximum.

As depicted in FIG. 4, in the case in which sandblasting treatment is not performed on the first outer electrode 3A, the residual stresses RS2 of the first outer electrode 3A are oriented in directions toward one-half of the height of the multilayer body 2 with respect to the lamination direction T. That is, in the case in which sandblasting treatment is not performed on the first outer electrode 3A, the residual stresses RS2 of the first outer electrode 3A are oriented toward the central side of the second conductor portion 302 in the lamination direction T. Specifically, the residual stress RS21 is oriented from the first main surface A1 side toward the second main surface A2 side. The residual stress RS22 is oriented from the second main surface A2 side toward the first main surface A1 side. As depicted in FIG. 4, when the residual stresses RS2 are present, the forces PT can be enhanced. Thus, electrostrictive crack resistance can be improved. However, in the first conductor portions 301, a force acts in such a direction as to cause separation of an end portion 3012 of the first conductor portion 301 on the central side of the main surface A, and thus possibly the flexural strength decreases.

Next, with reference to FIG. 5, a description is given of the residual stresses of the first outer electrode 3A in a case in which sandblasting is performed over the entire surface of the first outer electrode 3A. FIG. 5 is an enlarged cross-sectional view (LT cross-sectional view) of the multilayer ceramic capacitor 1Z of the comparative example in the case in which sandblasting treatment is performed over the entire surface of the first outer electrode 3A. In FIG. 5, solid arrows indicate residual stresses RS1 of the first outer electrode 3A. The residual stresses RS1 include a residual stress RS11 and a residual stress RS12. In FIG. 5, dashed arrows indicate the forces PT applied to the multilayer body 2 in the lamination direction T by the residual stresses RS1. The forces PT include the force PT1 and the force PT2. In FIG. 5, the maximum-thickness point MP2 indicates a point at which the thickness of the second conductor portion 302 is maximum.

As depicted in FIG. 5, when sandblasting is performed over the entire surface of the first outer electrode 3A, the residual stresses RS1 of the first outer electrode 3A are each oriented from the maximum-thickness point MP2 of the second conductor portion 302 toward the main surface A side. That is, when sandblasting is performed over the entire surface of the first outer electrode 3A, the residual stresses RS1 of the first outer electrode 3A are oriented from the central side of the second conductor portion 302 toward the outer side in the lamination direction T. As depicted in FIG. 5, when the residual stresses RS1 are present, forces act such that the end portions of the first conductor portions 301 on the central sides of the main surfaces A press the main surfaces A. Thus, the flexural strength can be improved. However, there is a possibility that the forces PT become weaker and the electrostrictive crack resistance decreases.

As described with reference to FIGS. 4 and 5, in the multilayer ceramic capacitor 1Z of the comparative example, it is difficult to achieve both improvement in the mechanical strength and improvement in the electrostrictive crack resistance.

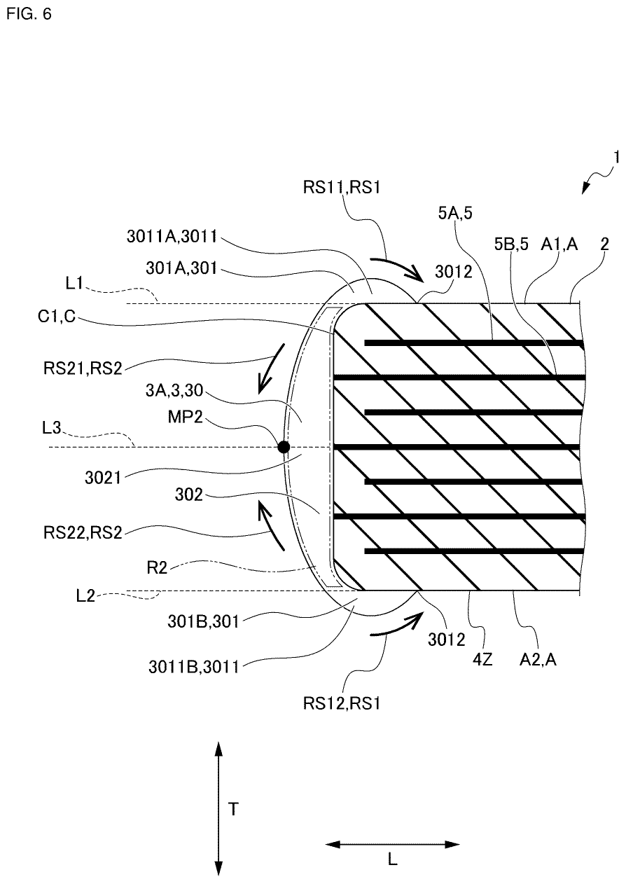

With reference to FIG. 6, the multilayer ceramic capacitor 1 according to the present example embodiment of the present invention is described. FIG. 6 is an enlarged cross-sectional view (LT cross-sectional view) of the multilayer ceramic capacitor 1 according to the present example embodiment of the present invention. In FIG. 6, the plated layer 31 is omitted. That is, in FIG. 6, only the underlying electrode layer 30 of the first outer electrode 3A is depicted.

As depicted in FIG. 6, the first conductor portions 301 include first residual stress portions 3011. Specifically, the first conductor portion 301A includes a first residual stress portion 3011A. The first conductor portion 301B includes a first residual stress portion 3011B. The residual stresses RS1 are present in the first residual stress portions 3011. In the example depicted in FIG. 6, the entire regions of the first conductor portions 301 are the first residual stress portions 3011, and the residual stresses RS1 in the first residual stress portions 3011 are oriented in directions away from the first end surface C1 with respect to the length direction L. The residual stresses in the first residual stress portions 3011 are each oriented in a direction toward the end portion 3012 of the first conductor portion located on the central side of the first main surface. In FIG. 6, the residual stress RS11 indicates the residual stress RS1 present in the first residual stress portion 3011A. The residual stress RS12 indicates the residual stress RS1 present in the first residual stress portion 3011B. It is preferable that the residual stress RS1 in the first residual stress portion 3011 be about 100 MPa or more, for example.

The second conductor portion 302 includes a second residual stress portion 3021. Residual stresses are present in the second residual stress portion 3021. In the example depicted in FIG. 6, the entire region of the second conductor portion 302 is the second residual stress portion 3021, and the residual stresses RS2 in the second residual stress portion 3021 are oriented in directions toward one-half of the height of the multilayer body with respect to the lamination direction T. The residual stresses RS2 in the second residual stress portion 3021 are oriented in directions toward the maximum-thickness point MP2 of the second conductor portion 302. Further, the residual stresses in the second residual stress portion 3021 are oriented in directions toward the center of the first end surface C1. That is, the residual stresses RS2 in the second residual stress portion 3021 are oriented in directions toward the position of the virtual line L3. In FIG. 6, the residual stress RS21 indicates the residual stress RS2 present on the first main surface A1 side relative to the virtual line L3 in the second residual stress portion 3021. The residual stress RS22 indicates the residual stress RS2 present on the second main surface A2 side relative to the virtual line L3 in the second residual stress portion 3021. The residual stress RS21 is oriented in a direction from the first main surface A1 side toward the position of the virtual line L3. The residual stress RS22 is oriented in a direction from the second main surface A2 side toward the position of the virtual line L3. It is preferable that the residual stress RS2 in the second residual stress portion 3021 be 65 MPa or more. It is preferable that the second residual stress portion 3021 be located in a region R2 within the range of the size of the multilayer body 2 in the lamination direction T. The region R2 is a region included between the virtual line L1 and the virtual line L2 in the second conductor portion 302.

As described with reference to FIG. 6, in the multilayer ceramic capacitor 1, the residual stresses RS1 in the first residual stress portions 3011 are oriented in the directions away from the first end surface C1 with respect to the length direction L. Thus, forces act such that the end portions of the first conductor portions 301 on the central sides of the main surfaces A press the main surfaces A. As a result, the flexural strength can be improved. Meanwhile, the residual stresses RS2 in the second residual stress portion 3021 are oriented in the directions toward one-half of the height of the multilayer body 2 with respect to the lamination direction T. Thus, the forces PT associated with the lamination direction T of the multilayer body 2 can be enhanced. As a result, the electrostrictive crack resistance can be improved. In this manner, in the multilayer ceramic capacitor 1, both improvement in the mechanical strength and improvement in the electrostrictive crack resistance can be achieved.

Further, the residual stresses RS1 in the first residual stress portions 3011 are each oriented in the direction toward the end portion 3012 of the first conductor portion 301 located on the central side of the main surface A. Thus, forces act such that the end portions of the first conductor portions 301 on the central sides of the main surfaces A press the main surfaces A. As a result, the flexural strength can be improved.

Further, the residual stresses RS2 in the second residual stress portion 3021 are oriented in the directions toward the maximum-thickness point MP2 of the second conductor portion 302. Thus, the forces PT associated with the lamination direction T of the multilayer body 2 can be enhanced. As a result, the electrostrictive crack resistance can be improved.

Further, the residual stresses in the second residual stress portion 3021 are oriented in the directions toward the center of the end surface C. Thus, the forces PT associated with the lamination direction T of the multilayer body 2 can be enhanced. As a result, the electrostrictive crack resistance can be improved.

Further, the residual stress in the first residual stress portion is about 100 MPa or more, for example. Thus, forces can be enhanced to allow the end portions of the first conductor portions 301 on the central sides of the main surfaces A to press the main surfaces A. As a result, the flexural strength can be improved.

Further, the residual stress RS2 in the second residual stress portion 3021 is about 65 MPa or more, for example. Thus, the forces PT associated with the lamination direction T of the multilayer body 2 can be enhanced. As a result, the electrostrictive crack resistance can be improved.

The second residual stress portion 3021 is located in the region R2 within the range of the size of the multilayer body 2 in the lamination direction T. Thus, the forces PT associated with the lamination direction T of the multilayer body 2 can be enhanced. As a result, the electrostrictive crack resistance can be improved.

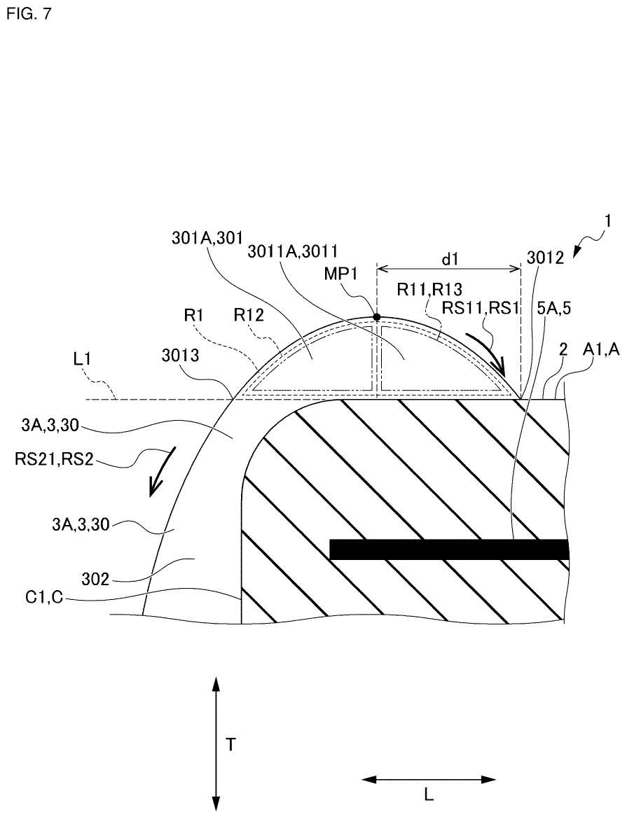

With reference to FIG. 7, a region in which the first residual stress portion 3011 is provided is described. FIG. 7 is an enlarged cross-sectional view (LT cross-sectional view) of the multilayer ceramic capacitor 1 according to the present example embodiment of the present invention. In FIG. 7, the plated layer 31 is omitted. That is, in FIG. 7, only the underlying electrode layer 30 of the first outer electrode 3A is depicted. In FIG. 7, a region R1 indicates the entire region of the first conductor portion 301A. The region R1 includes a region R11 and a region R12. The region R11 is a region on a side closer to the end portion 3012 of the first conductor portion 301A located on the central side of the first main surface A1, than a maximum-thickness point MP1 of the first conductor portion 301A. The region R12 is a region on a side farther from the end portion 3012 of the first conductor portion 301A than the maximum-thickness point MP1 of the first conductor portion 301A. A region R13 is a region within a range of about 100 μm, for example, from the end portion 3012 of the first conductor portion 301A toward the first end surface C1. In the example depicted in FIG. 7, the sizes of the region R12 and the region R13 are the same. The sizes of the region R12 and the region R13 may be different.

It is preferable that the region R13 be the first residual stress portion 3011 in the first conductor portion 301. That is, it is preferable that the vicinity of the end portion 3012 be the first residual stress portion 3011 in the first conductor portion 301. Due to the disposition of the first residual stress portion 3011 in the vicinity of the end portion 3012, a force acts such that the end portion 3012 presses the main surface A. Thus, the flexural strength can be improved.

Further, it is preferable that at least a portion of the region R11 be the first residual stress portion 3011 in the first conductor portion 301. It is more preferable that the entirety of the region R11 be the first residual stress portion 3011 in the first conductor portion 301. With this configuration, a force acts such that the end portion 3012 presses the main surface A. Thus, the flexural strength can be improved.

Further, it is preferable that the entirety of the region R1 of the first conductor portion 301A be the first residual stress portion 3011A. With this configuration, a force acts such that the end portion 3012 presses the main surface A. Thus, the flexural strength can be improved.

As described above with reference to FIG. 7, the region R13 within the range of about 100 μm, for example, from the end portion 3012 of the first conductor portion 301 toward the first end surface C1 is the first residual stress portion 3011. Due to the disposition of the first residual stress portion 3011 in the vicinity of the end portion 3012, a force acts such that the end portion 3012 presses the main surface A. Thus, the flexural strength can be improved.

Further, it is preferable that at least a portion of the region R11 be the first residual stress portion 3011 in the first conductor portion 301. With this configuration, a force acts such that the end portion 3012 presses the main surface A. Thus, the flexural strength can be improved.

Further, the entirety of the region R11 on the side closer to the end portion 3012 of the first conductor portion 301 than the maximum-thickness point MP1 of the first conductor portion 301 is the first residual stress portion 3011. With this configuration, a force acts such that the end portion 3012 presses the main surface A. Thus, the flexural strength can be improved.

Further, the entirety of the region R1 of the first conductor portion 301 is the first residual stress portion 3011. With this configuration, a force acts such that the end portion 3012 presses the main surface A. Thus, the flexural strength can be improved.

Next, a non-limiting example of a manufacturing method for the multilayer ceramic capacitor 1 according to the present example embodiment of the present invention is described.

Dielectric sheets for the dielectric layer and conductive paste for the inner electrode layer are prepared. The dielectric sheets and the conductive paste for the inner electrode contain a binder and a solvent. The binder and the solvent may be publicly-known ones.

The conductive paste for the inner electrode layer is printed in predetermined patterns on the dielectric sheets by, for example, screen printing, gravure printing, or the like. Thereby, the dielectric sheets on which a pattern of the first inner electrode layer is formed and the dielectric sheets on which a pattern of the second inner electrode layer is formed are prepared.

A portion that becomes the dielectric portion on the first main surface side is formed by laminating a predetermined number of dielectric sheets on which the pattern of the inner electrode layer is not printed. Subsequently, the first inner electrode layers and the second inner electrode layers are alternately stacked, thereby forming a portion that becomes the capacitance generating portion. Subsequently, a portion that becomes the second main-surface-side outer layer portion on the second main surface side is formed by laminating a predetermined number of dielectric sheets on which the pattern of the inner electrode layer is not printed. Thus, a multilayer sheet is fabricated.

A multilayer block is fabricated by pressing the multilayer sheet in the lamination direction by an isostatic press, for example.

A multilayer chip is obtained by cutting the multilayer block into a predetermined size. At this time, corner portions and ridge line portions of the multilayer chip may be rounded by barrel polishing or the like.

A multilayer body is fabricated by firing the multilayer chip. It is preferable that the firing temperature be about 900° C. or more and about 1400° C. or less, for example, although it depends on the materials of the dielectric layers and the inner electrode layers.

Next, the underlying electrode layer of the first outer electrode and the underlying electrode layer of the second outer electrode are formed on the first end surface and the second end surface of the multilayer body obtained by the firing. In a case of forming a baked layer as the underlying electrode layer, conductive paste including a glass component and a metal is applied, and thereafter baking treatment is performed to form the underlying electrode layer. It is preferable that the temperature of the baking treatment at this time be from about 700° C. to about 900° C., for example. In the present example embodiment, by using a dipping method, the underlying electrode layers are formed to extend not only on the first end surface and the second end surface but also to a portion of the first main surface, a portion of the second main surface, part of the first side surface, and a portion of the second side surface.

Next, with the end surfaces of the outer electrodes masked, only the first conductor portions (i.e., the folded portions) are subjected to sandblasting treatment. For example, the sandblasting treatment is performed with both end surface portions clamped between pieces of rubber having a thickness of about 0.03 mm, for example. By deformation of the rubber applied to the end surfaces, the end surface portions can be covered without a gap, and the degree of exposure of the folded portions can be adjusted by the thickness of the rubber. When the sandblasting time is longer, the residual stress toward the folded end portion of the first conductor portion (i.e., the folded portion) can be made greater, and thus flex-crack resistance can be more improved. On the other hand, if the sandblasting time is too long, the first conductor portion (i.e., the folded portion) is peeled off in some cases. Thus, it is preferable that the treatment time be, for example, from about 20 minutes to about 90 minutes.

With the above structure, the residual stress in the outer electrode folded portion, which affects the flex-crack, can be oriented in a direction toward the folded end portion, and the residual stress in the outer electrode end surface portion, which affects the electrostrictive crack, can be oriented in a direction toward the central portion of the end surface. This can achieve both improvement in the mechanical strength and improvement in the electrostrictive crack resistance.

Thereafter, plating is performed on the surfaces of the baked layers. In the present example embodiment, plated layers are formed over the underlying electrode layers in order of Ni plating and Sn plating.

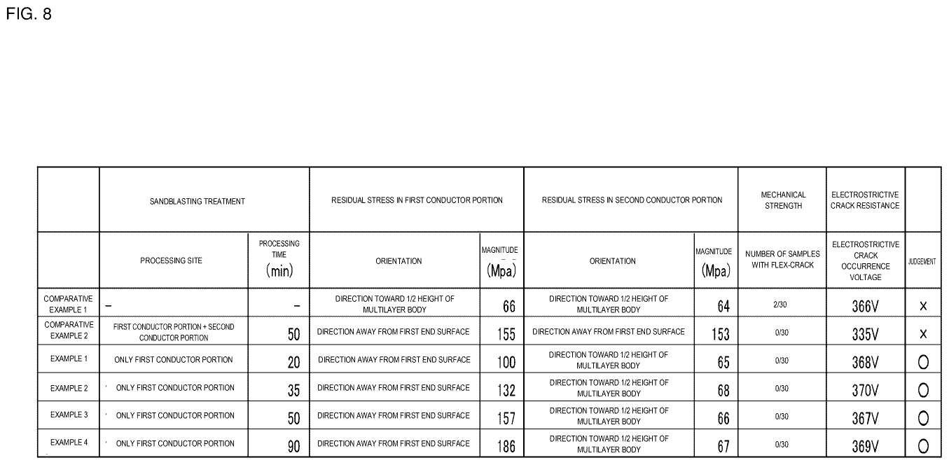

Next, with reference to FIG. 8, evaluation of comparative examples and examples is described. FIG. 8 is a table indicating experimental results according to the present example embodiment of the present invention.

Experimental data for a multilayer ceramic capacitor shown below is presented.
Dimension (L) of multilayer ceramic capacitor: 3.400 mm
Dimension (W) of multilayer ceramic capacitor: 2.620 mm
Dimension (T) of multilayer ceramic capacitor: 2.620 mm
Thickness of dielectric layer: 5.55 μm
Thickness of inner electrode layer: 1.10 μm
Number of first inner electrodes: 250
Number of second inner electrodes: 250
Thickness of first outer layer: 135 μm
Thickness of second outer layer: 135 μm
L-gap dimension: 160 μm
W-gap dimension: 140 μm

### Experimental Method

As the comparative examples, the following samples were prepared.
Comparative example 1: sample without sandblasting treatment
Comparative example 2: sample in which sandblasting treatment was performed on the first conductor portion and the second conductor portion

As the examples of example embodiments of the present invention, the following samples in which sandblasting treatment was performed only on the first conductor portion and the processing time was varied were prepared.
Example 1: processing time of 20 minutes
Example 2: processing time of 35 minutes
Example 3: processing time of 50 minutes
Example 4: processing time of 90 minutes

A flexural strength test was conducted as a mechanical strength test.

### Flexural Strength Test Conditions

Number of test samples: 30
Substrate thickness: 1.6 mm
Land thickness: 35 μm
Solder thickness: 200 μm
Deflection amount: 2.0 mm
Pressing jig: R1 (radius of jig tip: 1 mm)
Deflection holding time: 60 seconds

The crack inspection method was as follows. The chip after the test was removed from the substrate. Then, the chip was rotated by 90 degrees such that the substrate-side surface faced downward, and polishing was performed on the LT face obtained in this manner. Thereafter, cracks were checked at two sections, namely the beginning of the effective region and the W/2 cross-section. The observation was performed using a metallurgical microscope.

In the method for checking the electrostrictive crack resistance, a voltage was applied to the chip and thereafter the presence or absence of cracks was checked by ultrasonic flaw detection (SAT). From the relationship between the applied voltage and the crack occurrence rate, an average crack-occurrence voltage was estimated using a statistical method (for example, Weibull analysis). As a measuring instrument, an ultrasonic flaw detector (SAT) was used.

The method for measuring the residual stress was as follows.
Measuring instrument: micro X-ray diffractometer
Target peak: Cu (311)
E (Young's modulus): 129,800 MPa
ν (Poisson's ratio): 0.364
Measurement direction: L and T directions on the LT face

The orientation of the residual stress was a direction toward one-half of the height of the multilayer body or a direction away from the first end surface.

In FIG. 8, the “x” mark in the judgment column indicates that a failure occurred in the mechanical strength test or the electrostrictive crack resistance test. The “○” mark in the judgment column indicates that both the mechanical strength and the electrostrictive crack resistance could be achieved. In comparative example 1, a flex-crack occurred in the mechanical strength test. In comparative example 2, a decrease in the electrostrictive crack occurrence voltage occurred. In examples 1 to 4, favorable results could be confirmed for both the mechanical strength and the electrostrictive crack resistance. Accordingly, it could be confirmed that the multilayer ceramic capacitors according to example embodiments of the present invention achieve both the mechanical strength and the electrostrictive crack resistance.

Although various example embodiments according to the present disclosure have been described, they are presented as examples and are not intended to limit the scope of the invention. These novel example embodiments can be implemented in various other forms, and various omissions, substitutions, and modifications can be made without departing from the gist of the present invention. These example embodiments and modifications thereof are included within the scope and gist of the present invention, and are also included within example embodiments of the present invention set forth in the claims and the scope of equivalents thereof.

As with the first outer electrode 3A described with reference to FIGS. 1 to 8, it is preferable that the second outer electrode 3B also be configured such that the orientation of the residual stress in the first residual stress portion of the first conductor portion is different from the orientation of the residual stress in the second residual stress portion of the second conductor portion. As a result, it is possible to achieve both improvement in the mechanical strength and improvement in the electrostrictive crack resistance.

The configuration of the first conductor portion 301 according to the example embodiments described with reference to FIGS. 1 to 8 may also be applied to the first outer electrode 3A on the side surface B.

In the multilayer ceramic capacitor 1 described with reference to FIGS. 1 to 8, the outer electrode 3 includes the underlying electrode layer 30 and the plated layer 31. However, the present invention is not limited thereto. For example, the outer electrode 3 may include a layer different from the underlying electrode layer 30 and the plated layer 31. For example, the outer electrode 3 may include a conductive resin layer between the underlying electrode layer 30 and the plated layer 31. Including the conductive resin layer allows the conductive resin layer to function as a buffer layer, thus further reducing or preventing the occurrence of cracks in the multilayer ceramic capacitor 1.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers laminated and a plurality of inner electrode layers laminated on the dielectric layers, the multilayer body including main surfaces including a first main surface and a second main surface opposed to each other in a lamination direction, end surfaces including a first end surface and a second end surface opposed to each other in a length direction orthogonal to the lamination direction, and side surfaces including a first side surface and a second side surface opposed to each other in a width direction orthogonal to the lamination direction and the length direction;
a first outer electrode on the first end surface and on a portion of the main surfaces; and
a second outer electrode on the second end surface and on a portion of the main surfaces; wherein
the plurality of inner electrode layers include:
first inner electrode layers on the plurality of dielectric layers and extending to the first end surface; and
second inner electrode layers on the plurality of dielectric layers and extending to the second end surface;
the first outer electrode is connected to the first inner electrode layers;
the second outer electrode is connected to the second inner electrode layers;
the first outer electrode includes:
a first conductor portion on one of the main surfaces; and
a second conductor portion on the first end surface and coupled to the first conductor portion;
the first conductor portion includes a first residual stress portion in which a residual stress is present;
the second conductor portion includes a second residual stress portion in which a residual stress is present;
the residual stress in the first residual stress portion is oriented in a direction away from the first end surface with respect to the length direction; and
the residual stress in the second residual stress portion is oriented in a direction toward one-half of a height of the multilayer body with respect to the lamination direction.

2. The multilayer ceramic capacitor according to claim 1, wherein the residual stress in the first residual stress portion is oriented in a direction toward an end portion of the first conductor portion located on a central side of the one of the main surfaces.

3. The multilayer ceramic capacitor according to claim 1, wherein the residual stress in the second residual stress portion is oriented in a direction toward a maximum-thickness point of the second conductor portion.

4. The multilayer ceramic capacitor according to claim 1, wherein the residual stress in the second residual stress portion is oriented in a direction toward a center of the first end surface.

5. The multilayer ceramic capacitor according to claim 1, wherein the residual stress in the first residual stress portion is about 100 MPa or more.

6. The multilayer ceramic capacitor according to claim 1, wherein the residual stress in the second residual stress portion is about 65 MPa or more.

7. The multilayer ceramic capacitor according to claim 1, wherein a region within a range of about 100 μm from an end portion of the first conductor portion toward the first end surface is the first residual stress portion.

8. The multilayer ceramic capacitor according to claim 1, wherein at least a portion of a region on a side closer to an end portion of the first conductor portion located on a central side of the one of the main surfaces than a maximum-thickness point of the first conductor portion is the first residual stress portion.

9. The multilayer ceramic capacitor according to claim 8, wherein an entirety of the region on the side closer to the end portion of the first conductor portion than the maximum-thickness point of the first conductor portion is the first residual stress portion.

10. The multilayer ceramic capacitor according to Claim 1, wherein an entire region of the first conductor portion is the first residual stress portion.

11. The multilayer ceramic capacitor according to Claim 1, wherein the second residual stress portion is located in a region within a range of a size of the multilayer body in the lamination direction.

12. The multilayer ceramic capacitor according to Claim 1, wherein
a length in the length direction including the multilayer body and the outer electrodes is from about 0.10 mm to about 3.50 mm; and
a length in the width direction including the multilayer body and the outer electrodes is from about 0.05 mm to about 2.80 mm.

13. The multilayer ceramic capacitor according to claim 1, wherein the multilayer body has a rectangular or substantially rectangular parallelepiped shape.

14. The multilayer ceramic capacitor according to claim 1, wherein the multilayer body includes rounded ridge line portions and rounded corners.

15. The multilayer ceramic capacitor according to claim 1, wherein the multilayer body includes side gap portions.

16. The multilayer ceramic capacitor according to claim 1, wherein a total number of the first inner electrodes and the second inner electrodes is 500 or more and 2000 or less, a number of the first inner electrodes is 250 or more or 1000 or less, and a number of the second inner electrodes is 250 or more or 1000 or less.

17. The multilayer ceramic capacitor according to claim 1, wherein a thickness of each of the first inner electrode layers is about 0.4 μm or more and about 1.3 μm or less, and a thickness of each of the second inner electrode layers is about 0.4 μm or more and about 1.3 μm or less.

18. The multilayer ceramic capacitor according to claim 1, wherein each of the first outer electrode and the second outer electrode includes an underlying electrode layer and a plated layer.

19. The multilayer ceramic capacitor according to claim 1, wherein a dimension of the multilayer ceramic capacitor in the length direction is about 1.00 mm or more and about 3.50 mm or less, a dimension of the multilayer ceramic capacitor in the width direction is about 0.50 mm or more and about 2.80 mm or less, and a dimension of the multilayer ceramic capacitor in the lamination direction is about 0.50 mm or more and about 2.80 mm or less.

20. The multilayer ceramic capacitor according to claim 1, wherein a dimension of the multilayer ceramic capacitor in the length direction is about 0.10 mm or more and about 3.50 mm or less, a dimension of the multilayer ceramic capacitor in the width direction is about 0.05 mm or more and about 2.80 mm or less, and a dimension of the multilayer ceramic capacitor in the lamination direction is about 0.05 mm or more and about 2.80 mm or less.
